(19) United States
(12) Patent Application Publication
(10) Pub. No.: US 2013/0181370 A1
(43) Pub. Date: Jul. 18, 2013

(54) METHOD AND A SYSTEM FOR HANDLING PROCESSED WET CLAY BRICKS

(71) Applicant: Hossein Rafie, Takestan (IR)

(72) Inventor: Hossein Rafie, Takestan (IR)

(21) Appl. No.: 13/348,661

(22) Filed: Jan. 12, 2012

(51) Int. Cl. B28B 11/12; B29C 39/30

(52) U.S. Cl. 264/157; 425/150

(57) ABSTRACT

The various embodiments herein provide a method and system for handling wet clay bricks. The wet clay bricks are sectioned on the section table. The sectioned wet clay bricks are erected by an erect maker machine. The erect maker machine is connected to a stock maker machine to store a preset number of wet clay bricks. The wet clay bricks are loaded from the stock maker machine to an automatic loading and unloading tools, which is fixed to a shifting machine. The wet clay bricks are shifted through shifting vehicle to sunshiny locations and the wet clay bricks are unloaded to the ground from the shifting vehicle. Thus the embodiments herein provides a simple way to erect, load and unload wet clay bricks in a cost effective manner and also reduces the number of workers.

### BACKGROUND

1. Technical Field

The embodiments herein generally relate to a construction industry and field. The embodiments herein particularly relate to clay brick production industry and machinery for handling, erecting, storing, and storing wet raw clay bricks automatically. The embodiments herein more particularly relates to an automatic method and system for erecting, loading, transporting and unloading wet clay bricks.

2. Description of the Related Art

Most of the brick production centers are working in a traditional form or in a half mechanized way with high cost. Except the advanced countries, there isn't any considerable and inexpensive way for the people who do these jobs. There are different processes in clay brick production and the machinery needs to be improved and useful in each process.

The brick making process consists of the following steps: clay preparation, molding, drying and firing. Firstly water is added to the clay soil to make it more workable. In order to mold the bricks, size of the mold should be considered first. The clay mixture is pressed into rectangular molds. While drying the wet clay bricks, water will be removed to avoid cracking of bricks. The last step of brick making process is to fire the wet clay bricks using furnaces or shift the wet clay bricks to sunshiny locations.

After the wet clay bricks are molded, wet clay bricks have to be loaded and unloaded to the shifting machine, which requires more number of workers. Tractors and wagons are required to shift the loaded wet clay bricks to sunshiny locations. There are different processes in clay brick production and the machinery needs to be improved and useful in each process.

One of the most expensive and sensitive processes of production is the transition of wet clay brick from a press machine to open and sunny places for shriveling naturally. To produce clay brick in old method, we mix the stock material (soil and the necessary additives) and water in the press machine. This mixture is sectioned in the form of bars by machine. The main difficulty begins after this process because other stages should be carried out by hand. At least 12 workers are needed for loading, carrying and unloading the produced wet clays. Meanwhile we need 3 tractors and 15 wagons for carrying the products to sunshiny locations, so all the producers of clay brick need a machine that can remove all these problems, but it has been an abortive desire ever since. The embodiments herein can solve the problems and is a big step forward in the production of clay brick.

One of the prior art methods provide a brick handling and stacking apparatus which is capable of picking up a predetermined number of bricks at the picking station and releasing them at the release station. Such an arrangement enables an optimum spacing between the bricks. As a result more spacing is required in the arrangement of bricks.

Another prior art methods provide a brick handling system wherein the wet clay bricks after molding has to be fired using kiln cars or furnaces which requires more amount of coal or electricity to fire the wet clay bricks and also humans or separate machine to load the wet clay bricks into the furnaces or kiln cars. After the firing process, bricks have to be cooled. For the cooling stage, the temperature must be slow and steady. It is very difficult to maintain a particular temperature for the cooling process. And also the fired bricks take two or more weeks to get cooled.

Thus none of the currently available systems and methods provides an automatic way for handling, erecting, storing and unloading wet raw clay bricks in a cost effective and automatic manner.

Hence there is a need for a device which can overcome the drawbacks obtained by using furnaces, kiln cars, more number of workers, tractors and wagons for loading and unloading of wet clay bricks and also there is a need to use automatic techniques and machineries for erecting, loading, transporting and unloading of wet clay bricks in a cost effective manner without producing more wastages.

The above-mentioned shortcomings, disadvantages and problems are addressed herein and which will be understood by reading and studying the following specification.

### OBJECTS OF THE EMBODIMENTS

The primary object of the embodiments herein is to provide a method and system for erecting, loading, transporting and unloading of wet clay bricks at a lower cost.

Another object of the embodiments herein is to provide a system and method to remove the problem of loading, shipment and unloading of clay brick.

Yet another object of the embodiments herein is to provide a method and a system for handling processed wet clay bricks thereby eliminating the need for the native workers to work in such places because of difficulties in the production and using foreign laborers instead of the native workers.

Yet another object of the embodiments herein is to provide a method and a system for handling processed wet clay bricks in handling the loading and unloading of the bars thereby reducing the wastage of product very much and improving the quality of bricks.

Yet another object of the embodiments herein is to provide a method and system for erecting, loading, transporting and unloading of wet clay bricks thereby eliminating the high costs for repairing and maintaining expensive machines and providing cheap and economical machines.

Yet another object of the embodiments herein is to provide a method and a system for handling processed wet clay bricks thereby providing a mechanical and automatic method for transshipping wet clay bricks effectively and quickly in a cost effective manner.

Yet another object of the embodiments herein is to provide a method and a system for handling processed wet clay bricks thereby solving the problem of finding workers because of hardness of work and the use of foreign workers.

Yet another object of the embodiments herein is to provide a method and a system for handling processed wet clay bricks thereby eliminating the need for necessary preparations and welfare measurements of workers.

Yet another object of the embodiments herein is to provide a method and a system for handling processed wet clay bricks thereby improving the functional speed of system in transport and working.

Yet another object of the embodiments herein is to provide a method and a system for handling processed wet clay bricks thereby eliminating the need for high costs of the wages, insurance and other services.

Yet another object of the embodiments herein is to provide a method and a system for handling processed wet clay bricks in a cost effective and economical manner thereby lowering the prices of pressed clay bricks and mobility in structural section.

Yet another object of the embodiments herein is to provide a method and system for erecting, loading, transporting and unloading of wet clay bricks to produce very glossy bricks so that the walls of buildings are smoother and their surfaces are beautiful.

Yet another object of the embodiments herein is to provide a method and system for erecting, loading, transporting and unloading of wet clay bricks effectively and efficiently to reduce the amount of utilized cement among bricks and to prevent the wastage of time

Yet another object of the embodiments herein is to provide an erect maker machine for making the wet clay bricks vertical by 90° from the horizontal position.

Yet another object of the embodiments herein is to provide a stock maker machine to store the bricks supplied by the erect maker machine in a row-by-row manner efficiently and to store more number of wet clay bricks effectively for transportation.

Yet another object of the embodiments herein is to provide a loading and unloading device to automatically transfer the stacked wet clay bricks from the stock maker machine to the sunshiny place or area.

Yet another object of the embodiments herein is to provide a system for handling processed wet clay bricks to enable a component to be fixed to and removed from any movable heavy vehicle easily.

These and other objects and advantages of the embodiments herein will become readily apparent from the following detailed description taken in conjunction with the accompanying drawings.

### SUMMARY

The various embodiments herein provide a method for handling processed wet clay bricks. According to an embodiment herein, a method for handling processed wet clay bricks comprises of placing a wet muddy bar on a section table of an erect maker machine from a press machine and sectioning the wet muddy bar into a predetermined number of wet clay bricks on the section table. The sectioned row of wet clay bricks are then kept erected by an erect maker sheet of the erect maker machine and placed on a stock and storage band in a row-by-row manner. The erected row of wet clay bricks on the stock and storage band are loaded on a shifter machine by an automatic loading and unloading tools provided on the shifter machine. The wet clay bricks are then transported to the sunshiny area by the shifter machine and the wet clay bricks are unloaded on a ground at the sunshiny area by the automatic loading and unloading tools provided on the shifter machine.

The sectioned wet clay bricks from the section table are placed on the stock and storage band in a row by row manner, and wherein the stock and storage band is moved after a loading of each row of sectioned wet clay bricks, and wherein the stock and storage band is moved for a predetermined distance, after the loading of each row of sectioned wet clay bricks to create a room for placing a next row of sectioned wet clay bricks, by an electromotor which is operated by an activation of a micro switch and wherein the electromotor is stopped until the next row of wet clay bricks are placed on the stock and storage band.

According to one embodiment herein, the method for handling processed wet clay bricks further comprises sensing the wet muddy bar on the erect maker sheet by a micro switch, sectioning the wet muddy bar into a predetermined number of wet clay bricks and activating an electromotor connected to a gear system to rotate a telescopic arm connected to the erect maker sheet. The telescopic arm converts a rotating motion to a pendulum motion and erects the erect maker sheet along with the wet clay bricks and wherein the erect maker sheet is rotated by 90° to store a horizontally positioned the wet clay bricks into a vertical manner.

According to one embodiment herein, the loading of the wet clay bricks on a shifter machine comprises spraying a black oil on the wet clay bricks to move the wet clay bricks from the stock and storage band on to the carrier sheet, placing a mobile panel of the carrier sheet of the automatic loading and unloading tools around the wet clay bricks on the stock and storage band and pulling the mobile panel along with the wet clay bricks on the carrier sheet. A gradient of the carrier sheet is arranged to be equal to a gradient of the stock and storage band to move the wet clay bricks from the stock and storage band to the carrier sheet.

According to one embodiment herein, the wet clay bricks strikes the sensor after an erection of the wet clay bricks on the stock and storage band and wherein the sensor activates the electromotor to move the stock and storage band in a forward direction by a predetermined distance and wherein the sensor turns off the electromotor for allowing a next row of wet clay bricks to be placed on the stock and storage band.

According to one embodiment herein, the unloading of the wet clay bricks on a ground comprises placing one end of the carrier sheet on the ground by a vertical jacks, placing the mobile panel of the carrier sheet of the automatic loading and unloading tools around the wet clay bricks positioned on the carrier sheet and pushing the mobile panel along with the wet clay bricks to the ground. The shifter machine is moved backward and at the same time the horizontal jack on the automatic loading and unloading tools begins to come forward for fixing one or more rakes on the ground to unload the wet clay bricks on the ground.

According to one embodiment herein, one or more rakes of the mobile panel are activated by the vertical jacks to fix the mobile panel on the ground for preventing a movement of the mobile panel while unloading the wet clay bricks on the ground.

According to one embodiment herein, a control mechanism for the automatic loading and unloading tools, fixed in a driver's cabin of the shifter machine is activated to operate the automatic loading and unloading tools.

According to one embodiment herein, a system is provided for handling processed wet clay bricks. The system for handling processed wet clay bricks comprising an erect maker machine for sectioning the wet muddy bar and erecting the sectioned wet clay bricks, a stock maker machine provided with a stock and storage band for storing the sectioned wet clay bricks and a shifter machine for shifting the sectioned wet clay bricks from the stock maker machine to the sunshiny area.

According to one embodiment herein, the erect maker machine further comprises a section table for driving a wet muddy bar from the press machine and sectioning the wet muddy bar into a predetermined number of wet clay bricks, an erect maker sheet for placing a sectioned wet clay bricks, a micro switch for sensing the wet clay bricks on the erect maker sheet, an electromotor connected with a gear-box for rotating the erect maker sheet by 90° and a telescopic arm connected to the erect maker sheet for converting a rotating motion to a pendulum motion. The micro switch sends a drive signal to the electromotor to move the telescopic arm connected to the erect maker sheet and wherein the telescopic arm makes the erect maker sheet to rotate by 90 degrees, resulting in erecting the wet clay bricks on the stock and storage band.

According to one embodiment herein, the stock maker machine further comprises one or more sensors to detect the erected wet clay bricks and activate an electromotor to move the stock and storage band, one or more pillars for supporting the stock and storage band, a plurality of rollers connected on either side of the stock and storage band for rotating the stock and storage band and a reducer electromotor and a gear box for controlling a rotation of the plurality of rollers.

According to one embodiment herein, the stock and storage band is made up of a polyvinyl chloride (PVC) material, which is resistant to an oven oil and gasoline.

According to one embodiment herein, the plurality of rollers is connected to a reducer electromotor and gearbox by a link for controlling a rotation of the stock band on the plurality of rollers.

According to one embodiment herein, the shifter machine further comprises a frame and wherein the frame is attached to a main chassis of shifter machine.

According to one embodiment herein, the frame further comprises automatic loading tools for loading the wet clay bricks from the stock and storage band to the shifter machine, automatic unloading tools for unloading the wet clay bricks from the shifter machine to the ground at the sunshiny area and a hydraulic system.

According to one embodiment herein, the automatic loading tools further comprises a carrier sheet for storing the wet clay bricks, a mobile panel for loading the wet clay bricks from the stock and storage band to the carrier sheet, a horizontal jack connected to the mobile panel for allowing a horizontal movement of the mobile panel for loading the wet clay bricks from the stock and storage band to the carrier sheet and wherein the horizontal movement of the horizontal jacks is controlled by the hydraulic system and one or more vertical jacks connected to the carrier sheet for allowing a vertical movement of the carrier sheet while loading the wet clay bricks from the stock and storage band to the carrier sheet and wherein the vertical movement of the one or more vertical jacks is controlled by the hydraulic system.

According to one embodiment herein, the automatic unloading tool further comprises a carrier sheet for storing the wet clay bricks in a mobile panel for unloading the wet clay bricks from the carrier sheet to the ground, and a horizontal jack is connected to the mobile panel for allowing a horizontal movement of the mobile panel for unloading the wet clay bricks from the carrier sheet to the ground and wherein the horizontal movement of the horizontal jacks is controlled by the hydraulic system. One or more vertical jacks is connected to the carrier sheet for allowing a vertical movement of the carrier sheet while unloading the wet clay bricks from the carrier sheet to the ground and wherein the vertical movement of the one or more vertical jacks is controlled by the hydraulic system.

According to one embodiment herein, the hydraulic system further comprises a control handle fixed inside a driver's cabin for activating the horizontal jacks and the one or more vertical jacks and a hydraulic pump fixed at an end of the gear box for pumping an oil to secure the necessary force for the hydraulic system.

According to one embodiment herein, the control handle comprises a plurality of levers for controlling the movement of the carrier sheet and the mobile panel.

According to one embodiment herein, the driver's cabin is placed at a highest point in the shifter machine to view an operation of the horizontal jacks, the vertical jacks and the rakes during a loading and unloading operation of the wet clay bricks and to control a movement of the horizontal jacks, the vertical jacks and the rakes during a loading and unloading operation of the wet clay bricks.

These and other objects and advantages of the embodiments herein will become readily apparent from the following detailed description taken in conjunction with the accompanying drawings.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a topside perspective view of an erect maker machine and a stock maker machine, according to one embodiment herein.

FIG. 2A illustrates a topside perspective view of an automatic loading and unloading tools attached to a shifter machine, according to one embodiment herein.

FIG. 2B illustrates an exploded perspective view of an automatic loading and unloading tools attached to a shifter machine, according to one embodiment herein.

FIG. 3A illustrates a side view of a shifter machine fixed with an automatic loading and unloading tools, according to one embodiment herein.

FIG. 3B illustrates a front side perspective view of a shifter machine attached with an automatic loading and unloading tools with the mobile panel extended out of the carrier sheet, according to one embodiment herein.

FIG. 4 illustrates a top side view of a system comprising an erect maker machine, a stock maker machine and a shifter machine fixed with an automatic loading and unloading tools, according to one embodiment herein.

FIG. 5A illustrates a side view of a system during a transfer and stacking operation of wet clay bricks from a stock maker machine to a carrier sheet of the shifter machine, according to one embodiment herein.

FIG. 5B illustrates a topside perspective view of a system during a transfer and stacking operation of wet clay bricks from a stock maker machine to a carrier sheet of the shifter machine, according to one embodiment herein.

Although the specific features of the embodiments herein are shown in some drawings and not in others. This is done for convenience only as such feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by the way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a method for handling a processed wet clay bricks. The method for handling the processed wet clay bricks comprises placing a wet muddy bar on a section table of an erect maker machine from a press machine and sectioning the wet muddy bar into a predetermined number of wet clay bricks on the section table. The sectioned row of wet clay bricks are then erected by an erect maker sheet of the erect maker machine and transferred on a stock and storage band. The erected row of the wet clay bricks on the stock and storage band are loaded on a shifter machine by an automatic loading and unloading tools provided on the shifter machine. The wet clay bricks are then transported to the sunshiny area by the shifter machine and unloaded on a ground at the sunshiny area by the automatic loading and unloading tools provided on the shifter machine.

According to an embodiment herein, the sectioned wet clay bricks from the section table are placed on the stock and storage band in a row-by-row manner and the stock and storage band is moved after a loading of each row of sectioned wet clay bricks. The stock and storage band is moved by a predetermined distance, after the loading of each row of sectioned wet clay bricks to create a room for placing a next row of sectioned wet clay bricks, by an electromotor which is operated by an activation of a micro switch and wherein the electromotor is stopped until the next row of wet clay bricks are placed on the stock and storage band.

According to one embodiment herein, the method for handling processed wet clay bricks further comprises sensing the wet muddy bar on the erect maker sheet by a micro switch, sectioning the wet muddy bar into a predetermined number of wet clay bricks and activating an electromotor connected to a gear system to rotate a telescopic arm connected to the erect maker sheet. The telescopic arm converts a rotating motion to a pendulum motion and erects the erect maker sheet along with the wet clay bricks and wherein the erect maker sheet is rotated by 90° to store a horizontally positioned the wet clay bricks into a vertical manner.

According to one embodiment herein, the loading of the wet clay bricks on a shifter machine comprises spraying a black oil on the wet clay bricks to move the wet clay bricks from the stock and storage band to the carrier sheet, placing a mobile panel of the carrier sheet of the automatic loading and unloading tools around the wet clay bricks on the stock and storage band and pulling the mobile panel along with the wet clay bricks on the carrier sheet. A gradient of the carrier sheet is arranged to be equal to a gradient of the stock and storage band to move the wet clay bricks from the stock and storage band to the carrier sheet.

According to one embodiment herein, the wet clay bricks strikes the sensor after an erection of the wet clay bricks on the stock and storage band and wherein the sensor activates the electromotor to move the stock and storage band in a forward direction by a predetermined distance and wherein the sensor turns off the electromotor for allowing a next row of wet clay bricks to be placed on the stock and storage band.

According to one embodiment herein, the unloading of the wet clay bricks on a ground comprises placing one end of the carrier sheet on the ground by a vertical jacks, placing the mobile panel of the carrier sheet of the automatic loading and unloading tools around the wet clay bricks positioned on the carrier sheet, and pushing the mobile panel along with the wet clay bricks to the ground. The shifter machine is moved backward and at the same time the horizontal jack on the automatic loading and unloading tools begins to come forward for fixing one or more rakes on the ground to unload the wet clay bricks on the ground.

According to one embodiment herein, one or more rakes of the mobile panel are activated by the vertical jacks to fix the mobile panel on the ground for preventing a movement of the mobile panel while unloading the wet clay bricks on the ground.

According to one embodiment herein, a control mechanism for the automatic loading and unloading tools, fixed in a driver's cabin of the shifter machine is activated to operate the automatic loading and unloading tools.

The various embodiments herein provide a system for handling the processed wet clay bricks. The system for handling the processed wet clay bricks comprising an erect maker machine for sectioning the wet muddy bar and erecting the sectioned wet clay bricks. A stock maker machine is provided with a stock and storage band for storing the sectioned wet clay bricks and a shifter machine is provided for shifting the sectioned wet clay bricks from the stock maker machine to the sunshiny area.

According to one embodiment herein, the erect maker machine further comprises a section table for driving a wet muddy bar from the press machine and sectioning the wet muddy bar into a predetermined number of wet clay bricks, an erect maker sheet for placing a sectioned wet clay bricks, a micro switch for sensing the wet clay bricks on the erect maker sheet, an electromotor connected with a gear-box for rotating the erect maker sheet by 90° and a telescopic arm connected to the erect maker sheet for converting a rotating motion to a pendulum motion. The micro switch sends a drive signal to the electromotor to move the telescopic arm connected to the erect maker sheet and wherein the telescopic arm makes the erect maker sheet to rotate by 90 degrees, resulting in erecting the wet clay bricks on the stock and storage band.

According to one embodiment herein, the stock maker machine further comprises one or more sensors to detect the erected wet clay bricks and activate an electromotor to move the stock and storage band, one or more pillars for supporting the stock and storage band, a plurality of rollers connected to either side of the stock and storage band for rotating the stock and storage band and a reducer electromotor and a gear box for controlling a rotation of the plurality of rollers.

According to one embodiment herein, the stock and storage band is made up of a polyvinyl chloride (PVC) material, which is resistant to an oven oil and gasoline.

According to one embodiment herein, the plurality of rollers is connected to a reducer electromotor and gearbox by a link for controlling a rotation of the stock band on the plurality of rollers.

According to one embodiment herein, the shifter machine further comprises a frame and wherein the frame is attached to a main chassis of shifter machine.

According to one embodiment herein, the frame further comprises automatic loading tools for loading the wet clay bricks from the stock and storage band to the shifter machine, automatic unloading tools for unloading the wet clay bricks from the shifter machine to the ground at the sunshiny area and a hydraulic system.

According to one embodiment herein, the automatic loading tools further comprises a carrier sheet for storing the wet clay bricks, a mobile panel for loading the wet clay bricks from the stock band to the carrier sheet, a horizontal jack connected to the mobile panel for allowing a horizontal movement of the mobile panel for loading the wet clay bricks from the stock and storage band to the carrier sheet and wherein the horizontal movement of the horizontal jacks is controlled by the hydraulic system. One or more vertical jacks are connected to the carrier sheet for allowing a vertical movement of the carrier sheet while loading the wet clay bricks from the stock and storage band to the carrier sheet and wherein the vertical movement of the one or more vertical jacks is controlled by the hydraulic system.

According to one embodiment herein, the automatic unloading tool further comprises a carrier sheet for storing the wet clay bricks in a mobile panel for unloading the wet clay bricks from the carrier sheet to the ground and a horizontal jack is connected to the mobile panel for allowing a horizontal movement of the mobile panel for unloading the wet clay bricks from the carrier sheet to the ground. Wherein the horizontal movement of the horizontal jacks is controlled by the hydraulic system and one or more vertical jacks are connected to the carrier sheet for allowing a vertical movement of the carrier sheet while unloading the wet clay bricks from the carrier sheet to the ground and wherein the vertical movement of the one or more vertical jacks is controlled by the hydraulic system.

According to one embodiment herein, the hydraulic system further comprises a control handle fixed inside a driver's cabin for activating the horizontal jacks and the one or more vertical jacks and a hydraulic pump fixed at an end of the gear box for pumping an oil to secure the necessary force for the hydraulic system.

According to one embodiment herein, the control handle comprises a plurality of levers for controlling the movement of the carrier sheet and the mobile panel.

According to one embodiment herein, the driver's cabin is placed at a highest point in the shifter machine to view an operation of the horizontal jacks, the vertical jacks and the rakes during a loading and unloading operation of the wet clay bricks and to control a movement of the horizontal jacks, the vertical jacks and the rakes during a loading and unloading operation of the wet clay bricks.

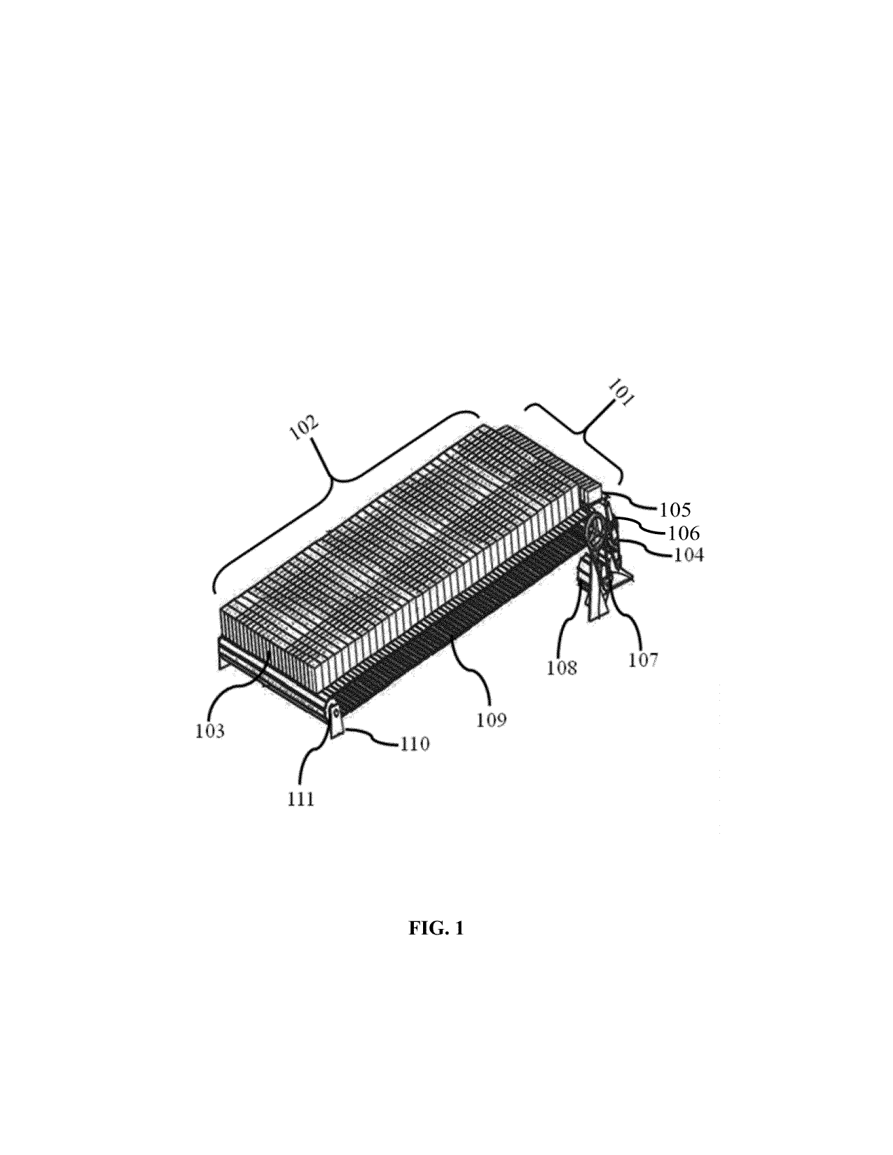

FIG. 1 illustrates a topside perspective view of an erect maker machine and a stock maker machine according to one embodiment herein. With respect to FIG. 1, the erect maker machine 101 is placed horizontally opposite to the section table, which produces the sectioned clay bricks. The erect maker machine 101 comprises an erect maker sheet 105, an electro motor 106, a gear box 104, a micro switch and a telescopic arm. A press machine issues the muddy bar. The muddy bar is driven on the section table and sectioned into predetermined size and number of wet clay bricks 103. These sectioned wet clay bricks 103 are in the horizontal position. The sectioned wet clay bricks 103 are driven onto the erect maker sheet 105 of the erect maker machine 102. The micro switch which is installed on the erect maker machine 101 senses the wet clay bricks 103 on the erect maker sheet 105 and activates the first electro motor system 106. The first electromotor system 106 is connected with the telescopic arm through the first gear box 104. Upon activation of the first electromotor system 106, the telescopic arm makes the rotational motion of the gear box 104 into the pendulous motion. The pendulous motion of the telescopic arm has an angular movement ranging from 0° to 90°. Thus the telescopic arm rotates the erect maker sheet 105 by 90° and stops. Since the wet clay bricks 103 are placed on the erect maker sheet 105, the wet clay bricks 103 also get rotated by 90° along with the erect make sheet 105. The erected wet clay bricks 103 are driven onto the stock and storage band 109 of the stock maker machine 102. The transferring of erected bricks onto the stock and storage band 109 of the stock maker machine 102 continues until the stock and storage band 109 of the stock maker machine 102 is completely filled with a predetermined number of wet clay bricks 103. The erect maker machine can be of a rectangular sheet 105 as shown in the FIG. 1.

The stock maker machine 102 consists of an electro motor 108, a gear box 107, a micro switch and a rectangular drawer with two rollers 111 attached on each end to ease the rotation of stock and storage band 109. Four pillars 110 are placed, one at each corner to provide a support to the rollers 111 and the rectangular drawer. A stock and storage band 109 (made of suitable material such as PVC) covers the rectangular drawer and the roller arrangement 111 on which the wet clay bricks 103 are moved. The second electro motor system 108 and the second gear box 107 are connected with at least one of the rollers 111 to rotate the stock and storage band 109. The rectangular drawer is provided to support the weight of the wet clay bricks 103 stacked on the stock and storage band 109. A micro switch is placed in a suitable place on the rectangular drawer. After the wet clay bricks 103 are erected by the erect maker machine 101, the wet clay bricks 103 strike the micro switch. As soon as the erected wet clay bricks 103 strike the micro switch, the micro switch activates the second electro motor 108. Since the second gear box 107 is connected to the second electromotor 108 so that the second gear box 107 also gets activated along with the second electromotor 108. The second gear box 107 makes the rollers 111 to rotate in a particular direction, thereby rotating the stock and storage band 109 also in the same direction as the rollers 111 rotate. The rotational motion of the stock and storage band 109 helps in driving the wet clay bricks 103 completely onto the stock and storage band 109. After erecting each row of the wet clay bricks 103 on the stock and storage band 109, the stock and storage band is moved by a pre set distance to receive the next row of wet clay bricks. The contact between the part of the erected wet clay bricks 103 (falling on the stock and storage band 109) and the stock and storage band 109 provides a frictional force against the rotational of the stock and storage 109. This frictional force helps to drive the complete erected wet clay bricks 103 onto the stock and storage band 109 during rotation (of the stock and storage band 109). The stock and storage band 109 rotates by a predetermined distance stops afterwards thereby leaving the space for next row of the wet clay bricks 103. In this way, one row of the wet clay bricks 103 get stocked on the stock and storage band 109 leaving a space for receiving the next row of the erected wet clay bricks 103. The process of accumulating the erected wet clay bricks 103 in a row-by-row manner continues until the stock and storage band 109 receives the predetermined number of the wet clay bricks 103 from the erect maker machine 101. After the predetermined number of the erected wet clay bricks 103 are transferred onto the stock and storage band 109, both the stock maker machine 102 and the erect maker machine 101 stops operating. The erect maker machine 101 and the stock maker machine 102 again start the erecting and stacking process after the stacked wet clay bricks 103 get completely transferred to the carrier sheet of the automatic loading and unloading tools.

In an example, the muddy bar which is obtained from the press machine is sectioned into 25 wet clay bricks at a time. The sectioned row of wet clay bricks are driven on the erect maker machine and are erected. The first row of 25 erected wet clay bricks are driven on the stock and storage band 109. The stock and storage band 109 moves automatically by 11 cm in a forward direction and the next row containing a predetermined amount of erected wet clay bricks 103 are placed on the stock maker machine 102. The process automatically continues until 1000 wet clay bricks 103 are accumulated on the stock and storage band 109 and the wet clay bricks 103 are loaded to the shifting machine.

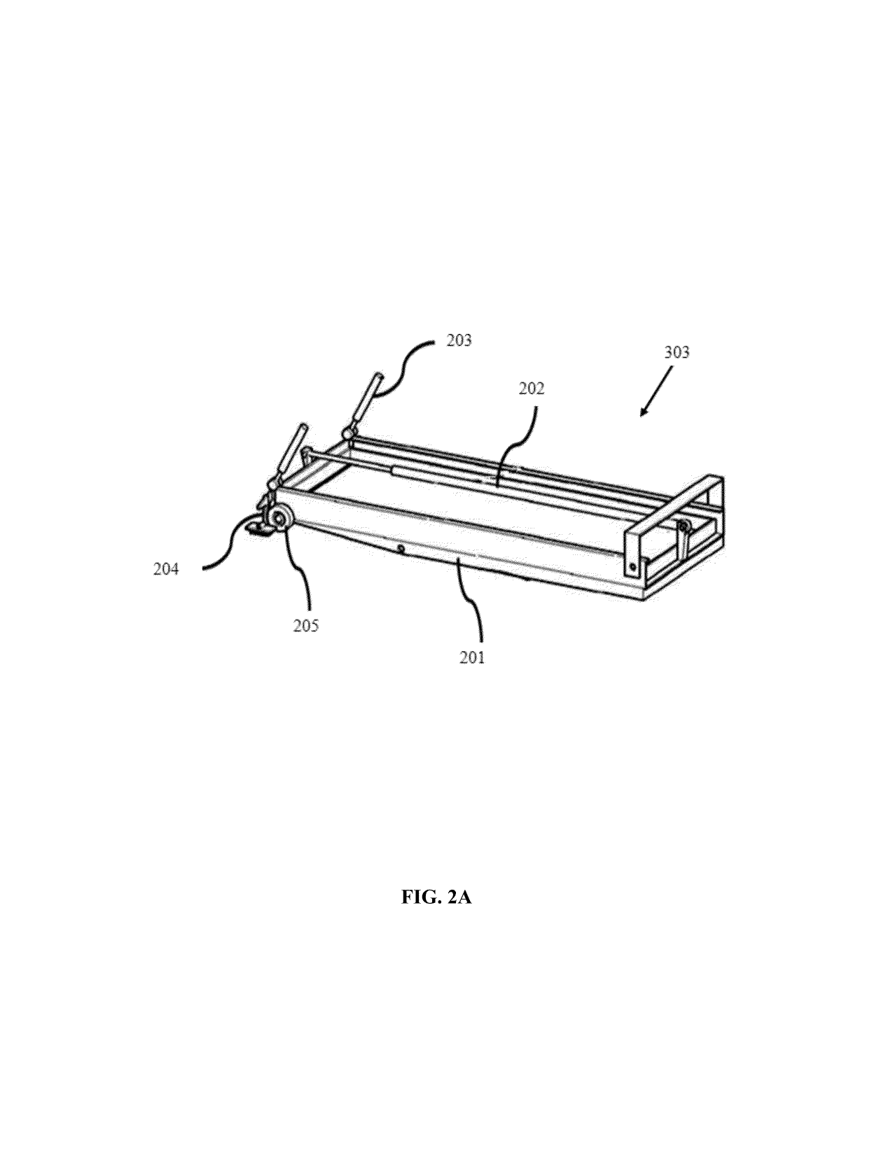

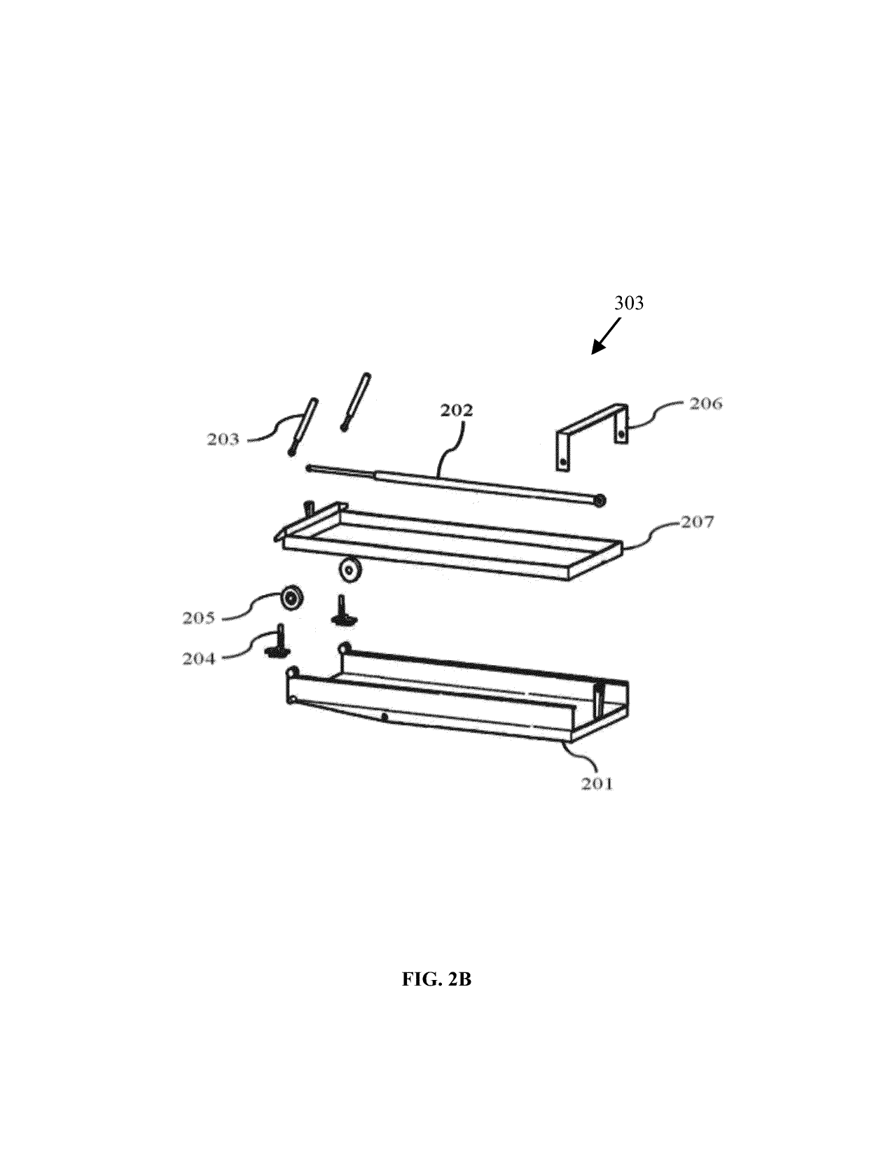

FIG. 2A illustrates a side perspective view of an automatic loading and unloading tools attached to the shifter machine according to one embodiment herein. With respect to FIG. 2A, the automatic loading and unloading tools 303 are used to load the wet clay bricks from the stock and storage band to carrier sheet 201 and unload the wet clay bricks from the carrier sheet 201 to the ground. The carrier sheet 201 is a component of the automatic loading and unloading tools 303 where the wet clay bricks are loaded and kept for transportation. The loading of the wet clay bricks from the stock and storage band onto the carrier sheet 201 of the automatic loading and unloading tools is accomplished through the mobile panel. The to and fro motion of the horizontal jack 202 helps the mobile panel to move and reach out onto the set of wet clay bricks and slides towards the carrier sheet 201. The bottom of horizontal jack 202 is fixed to the rear part of carrier sheet 201 and front part of horizontal jack 202 is fixed to the front part of the mobile panel. The vertical jack 203 is provided at the front side of the automatic loading and unloading tools 303. The up and down movement provided by the vertical jacks 203 helps the carrier sheet 201 to align with the stock and storage band for the loading of the stacked wet clay bricks. The rakes 204 are present at the bottom of front side of the carrier sheet 201. The rakes 204 are embedded on the ground to provide stability to the automatic loading and unloading tools 303 during an unloading process.

FIG. 2B illustrates an exploded perspective view of the automatic loading and unloading tools attached to shifter machine according to one embodiment herein. With respect to FIG. 2B, the automatic loading and unloading tools transfers the wet clay bricks from a stock and storage band on to the carrier sheet 201. The carrier sheet 201 is a component of automatic loading and unloading tools where all the wet clay bricks are accommodated for transportation. The carrier sheet 201 is fixed to the frame of the automatic loading and unloading tools, which is attached below the front part of the shifter machine. The automatic loading and unloading tools houses several other integral components, which are explained hereof. The carrier sheet 201 consists of mobile panel 207, which is placed inside the carrier sheet 201. The mobile panel 207 is a hollow rectangular shape casing having the total area enough to accommodate entire heap of the wet clay bricks. The mobile panel 207 helps to slide the housed wet clay bricks from the stock and storage band on to the carrier sheet 201 of the automatic loading and unloading tools. The hollow rectangular structure of the mobile panel 207 prevents the downfall of wet clay bricks during the shifting of the wet clay bricks from stock and storage band on to the carrier sheet 201. The mobile panel 207 is attached to a horizontal jack 202; one or more vertical jacks 203 and one or more pair of rakes 204. The bottom of horizontal jack 202 is installed to the back of carrier sheet 201 and front part of horizontal jack 202 is fixed to the front part of the mobile panel 207. The horizontal jack 202 projects the mobile panel 207 to reach out onto the set of wet clay bricks accumulated on the stock and storage band. After the mobile panel 207 is set around the wet clay bricks, the horizontal jack 202 pulls the mobile panel 207 towards the carrier sheet 201. This operation in turn makes the housed bricks to slide inside the mobile panel 207 and also makes the bricks to slide towards the carrier sheet 201. The mobile panel 207 moves from its location in a forward direction and in a backward direction with the help of the horizontal jack 202 keeping the carrier sheet 201 intact in its place. The vertical jacks 203 are fixed on the front side of the carrier sheet 201. The vertical jacks 203 helps to move the carrier sheet 201 in an upward direction and in a downward direction. The vertical jacks 203 help the carrier sheet 201 to align with the level of the stock and storage band for transferring the wet clay bricks without any damage and hindrance. Before transferring the wet clay brick onto the carrier sheet 201, black oil is sprayed over the carrier sheet 201 to reduce the friction between the surface of carrier sheet 201 and the wet clay bricks to ease the shifting of the wet clay bricks 103. The mobile panel 207 is further connected with a pair of rakes 204. The rakes 204 are embedded on the ground, which acts as a support to the automatic loading and unloading tools. The rakes 204 provide stability to the mobile panel 207 during an unloading process of the wet clay bricks on the ground. The rakes 204 are free to move through a preset angle, which makes the rakes 204 suitable for placing over an uneven ground. The carrier sheet 201 is further connected with one set of small wheel 205 fixed at the two corners of the front part of the carrier sheet 201. These wheels 205 help the carrier sheet 201 to set on the ground at a certain height during an unloading process of the wet clay bricks 103. The wheels 205 provide a smooth movement to the carrier sheet 201 when the carrier sheet is lowered to the ground during the unloading process of the wet clay bricks 103. Thus the absence of wheels 205 may damage the bottom of the carrier sheet during an unloading process. A mechanical support 206 is fixed to the frame to assembly of the automatic loading and unloading tools. The mechanical support 206 prevents perturbations in automatic loading and unloading tools, thereby protecting the deformation of the wet clay bricks.

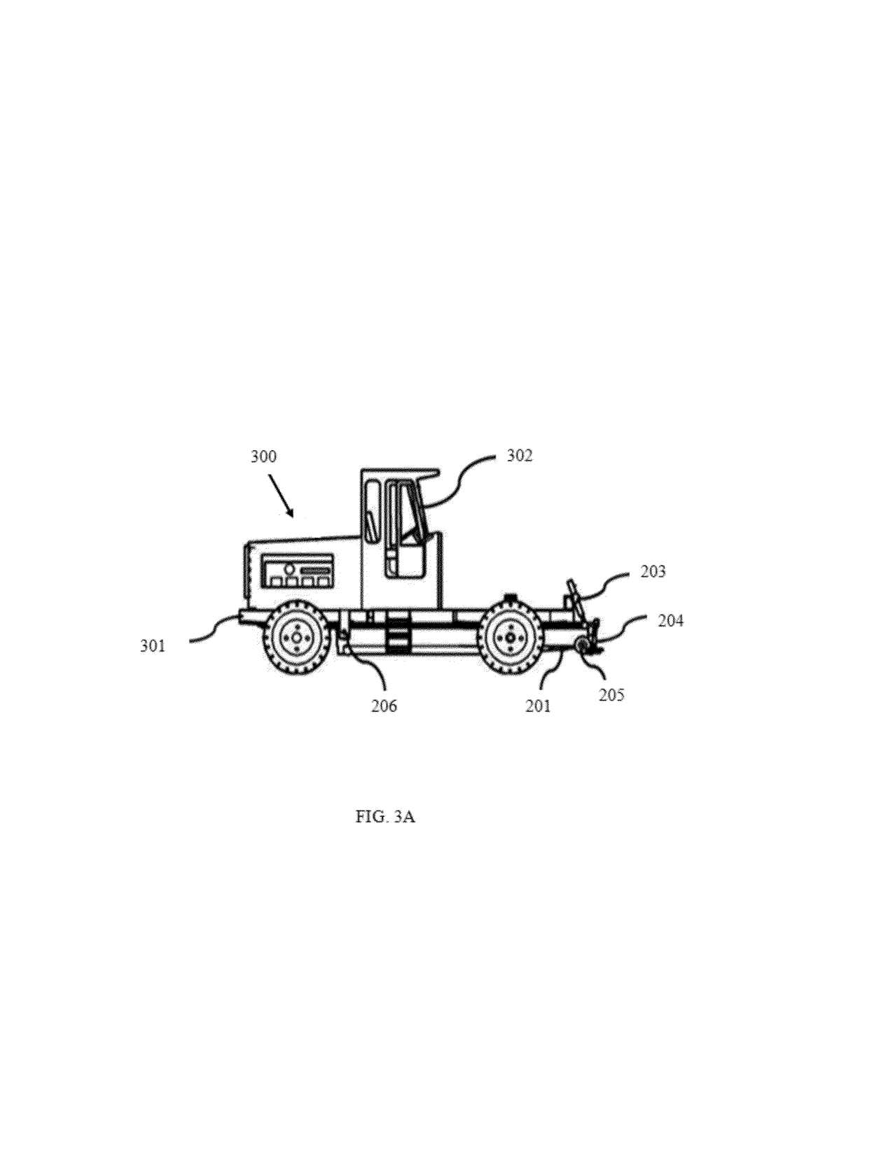

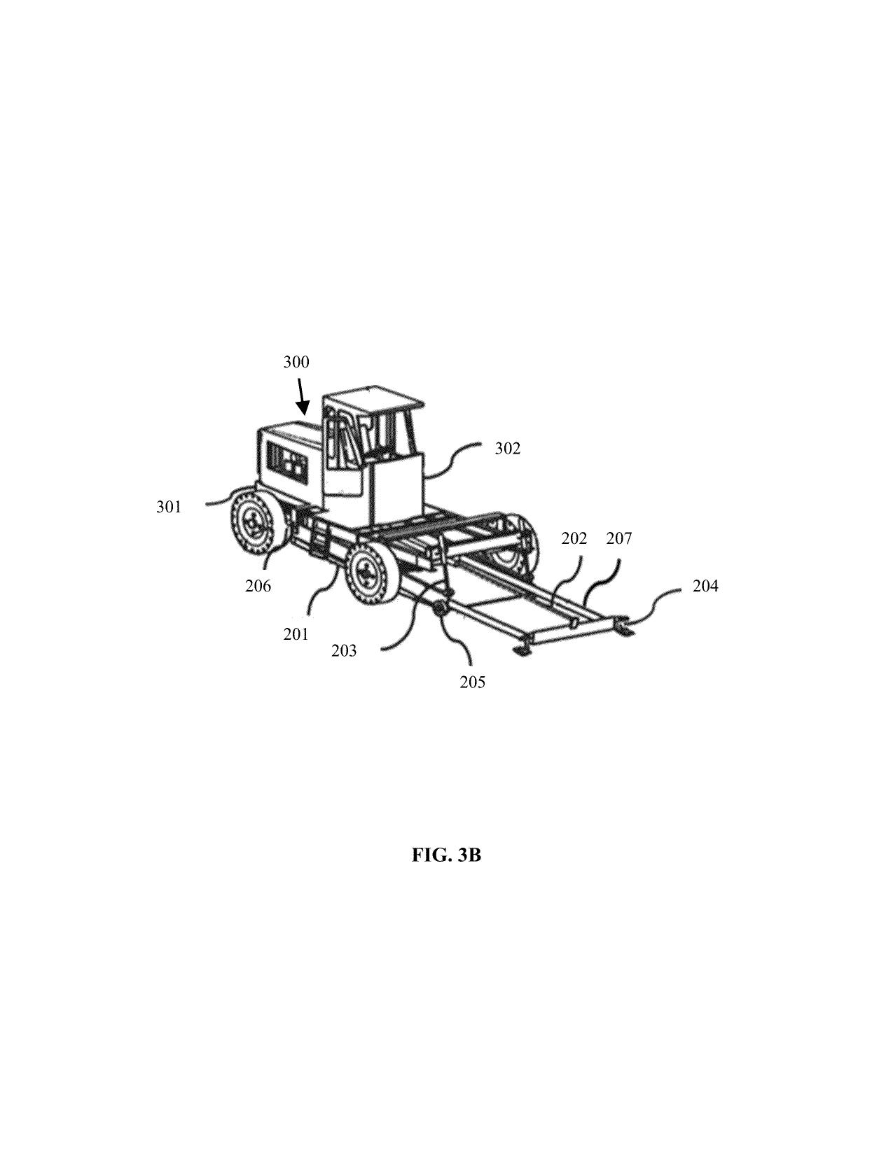

FIG. 3A illustrates a side view of the shifter machine fixed with the automatic loading and unloading tools, according to one embodiment herein. With respect to FIG. 3A, the assembly of automatic loading and unloading tools is fixed to the frame which is further attached to the main chassis 301 of the shifter machine 300 and positioned below the driver's cabin 302. The automatic loading and unloading tools are fixed to the frame through a mechanical support 206. The shifter machine 300 is a movable vehicle that facilitates the transportation of the loaded wet clay bricks in the sunshiny place. The shifter machine 300 also facilitates the attachment of the frame appended with the automatic loading and unloading tools 303 to the main chassis 301 of the shifter machine 300. The automatic loading and unloading tools comprises a carrier sheet 201, a mobile panel, one or more vertical jacks 203 and a horizontal jack. The bottom end of the horizontal jack is connected to rear part of the carrier sheet 201 and the top end of the horizontal jack is connected to the front part of the mobile panel. The mobile panel is a movable part of the automatic loading and the unloading tools 303, which is projected out of the carrier sheet 201 with the help of the horizontal jack. The mobile panel is a hollow rectangular casing, so the wet clay bricks (stacked on the stock band) get housed into the mobile panel. The wet clay bricks are slided onto the carrier sheet 201 from the stock and storage band along with the mobile panel by the help of the horizontal jack. The carrier sheet 201 is an immobile storage compartment of the automatic loading and unloading tools where the wet clay bricks are stocked for their safe transportation. The mobile panel is further connected with a pair of the racks 204. The racks 204 get embedded on the ground to prevent the movement of the mobile panel during the unloading process. The movement of the racks 204 (in the vertical direction) is controlled through the control panel provided in the driver's cabin 302. The carrier sheet 201 is connected with a pair of the small wheels 205. These wheels 205 facilitate a smooth movement of the carrier sheet 201 on the ground during an unloading operation of the wet clay bricks. The vertical jacks 203 are provided to move the carrier sheet 201 of the automatic loading and unloading tools upwards and downwards while loading and unloading the wet clay bricks. The control panel provided in the driver's cabin 302 is connected with a hydraulic system. The control panel controls the movement of the horizontal jack, the vertical jacks and the racks (connected to the mobile panel) with the help of the hydraulic system. The hydraulic system also controls the working of a hydraulic pump, which is provided to pump the black oil on the carrier sheet 201 to provide a frictionless transition of the wet clay bricks from the stock and storage band onto the carrier sheet 201.

FIG. 3B illustrates a topside perspective view of the shifter machine attached with an automatic loading and unloading tools with the mobile panel extended out of the carrier sheet. With respect to FIG. 3B, the automatic loading and unloading tools are assembled and connected through a mechanical support 206 to the frame, which is fixed to the main chassis 301 of the shifter machine 300. The automatic loading and unloading tools comprises the carrier sheet 201, the mobile panel 207, the horizontal jack 202 and the vertical jacks 203. The horizontal jack 202 facilitates a to and fro motion of the mobile panel 207 during the loading and unloading process of the wet clay bricks. The vertical jacks 203 facilitate an up and down movement of the carrier sheet 201 during the loading and unloading process of the wet clay bricks. During the loading process of the wet clay bricks onto the carrier sheet 201, the mobile panel 207 is projected out of the carrier sheet 201. The total area of the mobile panel 207 is formulated in such a way that it houses completely the wet clay bricks stacked on the stock and storage band of the stock maker machine. The housed wet clay bricks are slided smoothly onto the carrier sheet 201 by an inward movement of the mobile panel 207 with help of the horizontal jack 202. After the complete set of the wet clay bricks are transferred onto the carrier sheet 201, the housed wet clay bricks are transported to the sunshiny area with help of the shifter machine 300. The transported wet clay bricks are then unloaded on the ground with the help of the automatic loading and unloading tools.

During the unloading process of the wet clay bricks, the carrier sheet 201 is lowered to a certain height so that it reaches the ground. On reaching the ground, the rakes connected to the mobile panel 207 are embedded on the ground. These rakes prevent a movement of the mobile panel 207 and ensure a smooth transition of the wet clay bricks from the carrier sheet 201 onto the ground. After the fixation of the rakes on the ground, the mobile panel 207 is extended out of the carrier sheet 201 and simultaneously the shifter machine 300 is also moved backwards. The speed of the shifter machine 300 and the speed of the projection of the mobile panel 207 out of the carrier sheet 201 are same. Since the front end of the mobile panel 207 is fixed with the help of the rakes, the movement of the shifter machine 300 causes the movement of the carrier sheet 201 (fixed to the main chassis the shifter machine 300 through the frame) in a backward direction. The forward movement of the mobile panel 207 and the backward movement of the carrier sheet 201 at the same speed results in opening up a passage in the automatic loading and unloading tools. The passage so resulted enables a slow, smooth and continuous transfer of the wet clay bricks to the ground. After the complete transition of the wet clay bricks from the carrier sheet 201 to the ground, the rakes are removed off from the ground. Following the removal of the rakes from the ground, the mobile panel 207 is drawn back into the carrier sheet 201 and the carrier sheet 201 is moved upwards to the initial position with the help of vertical jacks 203. The automatic loading and unloading tool is moved over the ground with the help of the wheels 205. The entire loading and unloading operation of the wet clay bricks are monitored by a control system provided in the driver cabin 302.

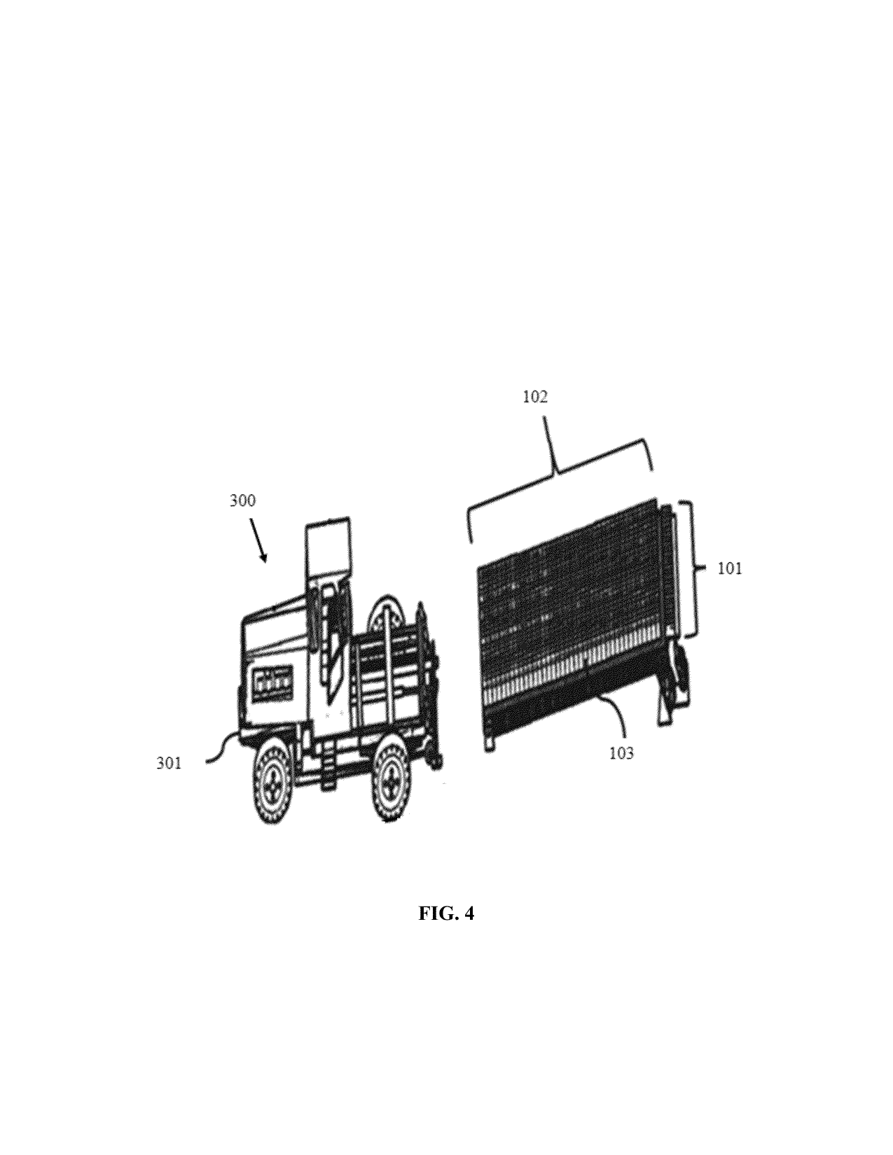

FIG. 4 illustrates a topside view of a system comprising the erect maker machine, stock maker machine and the shifter machine connected with the automatic loading and unloading tools. With respect to FIG. 4, the automatic loading and unloading tools are assembled and connected through a mechanical support to the frame, which is fixed to the main chassis 301 of the shifter machine 300. The sectioned wet clay bricks 103 are transferred from the section table to the erect maker machine 101. The wet clay bricks 103 are then erected on the erect maker machine 101 by 90°. The erected wet clay bricks 103 are transferred to the stock and storage band of the stock maker machine 102. After a predetermined set of wet clay bricks 103 are stacked on the stock band, the erect maker machine 101 and the stock maker machine 102 stops. The shifter machine 300 then sets the gradient of the automatic loading and unloading tools with help of the vertical jacks at an angle, which is equal to an angle at which the stock and storage band is lying. The synchronization facilitates the smooth transition of the wet clay bricks 103 from the stock and storage band of the stock maker machine 102 to the carrier sheet of the automatic loading and unloading tools. The mobile panel fitted to the carrier sheet in the automatic loading and unloading tools is projected out to house the wet clay bricks 103 stacked on the stock band with help of the horizontal jack. The wet clay bricks 103 are slided from the stock and storage band onto the carrier sheet along with the mobile panel. The transferred set of the wet clay bricks 103 on the carrier sheet are ready to be shifted to the sunshiny place through the shifter machine 300 and unloaded to the ground. The loading and unloading of the wet clay bricks 103 onto the carrier sheet from the stock and storage band through automatic loading and unloading tools is controlled through the control panel provided in the driver's cabin.

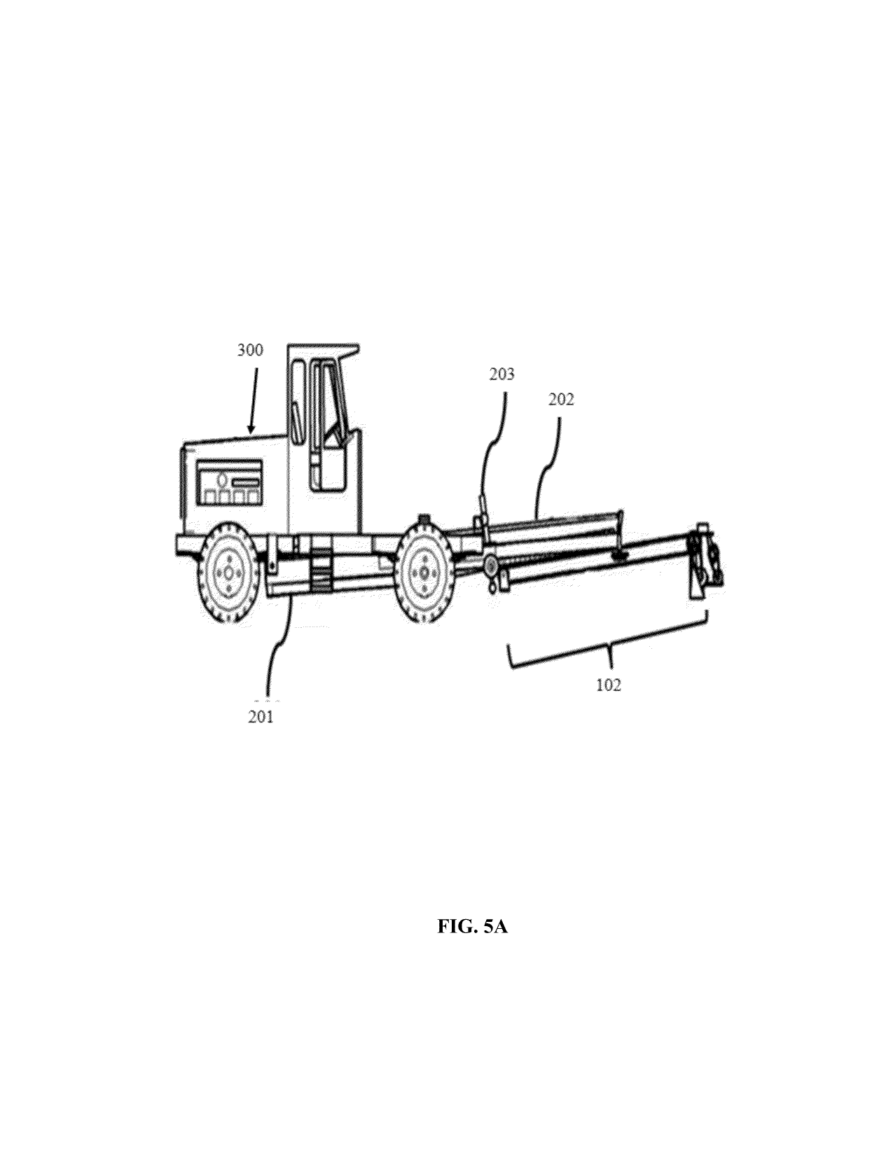

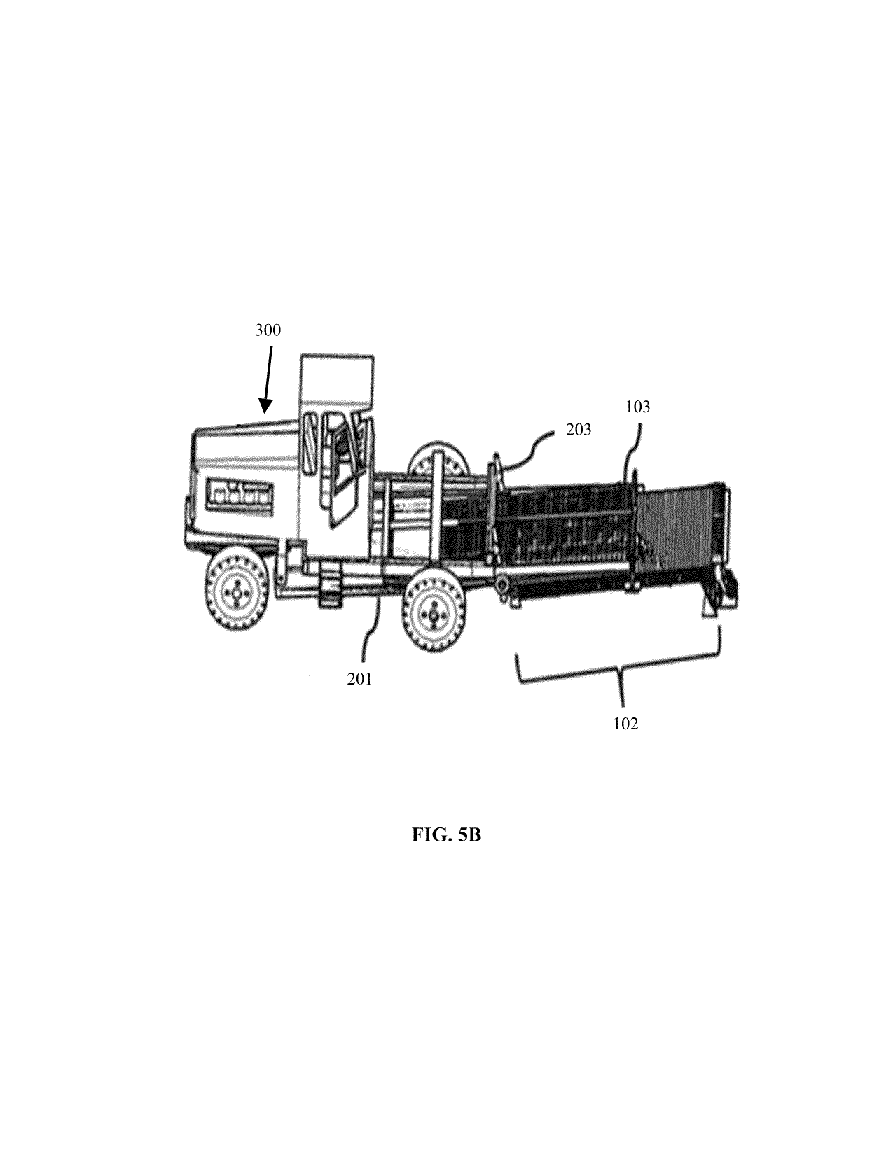

FIGS. 5A and 5B respectively illustrate a side view and a topside perspective view of a system during a transfer of a heap of wet clay bricks from the stock maker machine to the carrier sheet of the shifter machine. With respect to FIG. 5A and FIG. 5B, the stock maker machine 102 is capable of storing the produced wet clay bricks 103. The sectioned and erected wet clay bricks 103 are transferred from the erect maker machine onto the stock maker machine 102. After predetermined number of operations, the erected wet clay bricks 103 are continuously transferred to accumulate a predetermined heap of wet clay bricks 103 on the stock maker machine 102. This heap of the wet clay bricks 103 are then transferred onto the carrier sheet 201 of the shifter machine 300 with help of the mobile panel. The carrier sheet 201 of shifter machine 300 stores the heap of wet clay bricks 103, which is transported to the open area having bright sunshine. For the transfer of the wet clay bricks 103 from the stock maker machine 102 to the carrier sheet of the shifter machine 300, the carrier sheet is inclined at a certain angle with the help of vertical jack 203. The angle of inclination is such that the carrier sheet 201 synchronizes with the stock maker machine 102. At the time of loading, the mobile panel is projected out of the carrier sheet 201 like a drawer and reaches onto the wet clay bricks 103 stacked on the stock band. With the help of horizontal jack 202, which is capable of moving the mobile panel forward and backward on the carrier sheet, the wet clay bricks 103 are slided back on the carrier sheet 201.

The shifter machine is not only used for loading the heap of wet clay bricks, but is also used for unloading the wet clay bricks from shifter machine to the ground. During the unloading of the wet clay bricks, the carrier sheet is lowered to a certain height so that it reaches the ground. On reaching to the ground, the rakes connected to the mobile panel are embedded on the ground. These rakes prevent the movement of the mobile panel and ensure the smooth transition of the wet clay bricks from the carrier sheet onto the ground. After the fixation of the rakes on the ground, the mobile panel is extended out of the carrier sheet and the shifter machine is moved backwards simultaneously. The speed of the shifter machine and the speed of the projection of the mobile panel out of the carrier sheet are same. Since the mobile panel's front end is fixed with the help of the rakes, the movement of the shifter machine provides the movement of the carrier sheet (fixed to the main chassis the shifter machine through the frame) in backward direction. The forward movement of the mobile panel and the backward movement of the carrier sheet results in opening up a passage in the automatic loading and unloading tools. Thus the resulted passage facilitates a slow, smooth and continuous transfer of the wet clay bricks onto the ground. After the complete transition of the wet clay bricks from the carrier sheet to the ground, the rakes are removed off from the ground. Following the removal of the rakes from the ground, the mobile panel is drawn back into the carrier sheet and the carrier sheet is moved upwards back to the initial position with the help of vertical jacks.

The various embodiments herein provide a simple method for an automatic handling of the processed wet clay bricks. The method for erecting, loading and unloading of the wet clay bricks disclosed in the embodiments herein provides a cost effective and easy process by reducing the number of workers required for the above work.

The various embodiments herein provide an automatic method to transport the wet clay bricks from the brick making plant to the sunshiny locations for shriveling naturally. The automatic machine for erecting, storing and removing of raw clay reduces the manufacturing cost of bricks by avoiding the usage of furnaces or kiln cars to fire the wet clay bricks and use of the sunshiny locations to dry the wet clay bricks. The embodiments herein provide a feasibility of fitting the shifting machine to any movable heavy vehicle. The embodiments herein have the feature of maintaining the size and shape of wet clay bricks (glossy bricks) during erecting, loading and unloading process.

The foregoing description of the specific embodiments herein will so fully reveal the general nature of the embodiments herein that others can, by applying current knowledge, readily modify and/or adapt for various applications such specific embodiments herein without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the embodiments herein with modifications. However, all such modifications are deemed to be within the scope of the claims.

It is also to be understood that the following claims are intended to cover all of the generic and specific features of the embodiments described herein and all the statements of the scope of the embodiments, which as a matter of language might be said to fall there between.

What is claimed is:

1. A method for handling processed wet clay bricks, the method comprises:
placing a wet muddy bar on a section table of an erect maker machine from a press machine;
sectioning the wet muddy bar into a predetermined number of wet clay bricks on the section table;
erecting and placing a row of wet clay bricks on a stock and storage band by an erect maker sheet of the erect maker machine;
loading the wet clay bricks on a shifter machine by an automatic loading and unloading tools provided on the shifter machine;
transporting the wet clay bricks to a sunshiny area by the shifter machine; and
unloading the wet clay bricks on a ground at the sunshiny area by the automatic loading and unloading tools provided on the shifter machine.
wherein the sectioned wet clay bricks from the section table are placed on the stock and storage band in a row by row manner, and wherein the stock and storage band is moved after a loading of each row of sectioned wet clay bricks, and wherein the stock and storage band is moved by a predetermined distance, after the loading of each row of sectioned wet clay bricks to create a room for placing a next row of sectioned wet clay bricks, by an electromotor which is operated by an activation of a micro switch and wherein the electromotor is stopped until the next row of wet clay bricks are placed on the stock and storage band.

2. The method according to claim 1, further comprises:
sensing the wet muddy bar on the erect maker sheet by a micro switch;
sectioning the wet muddy bar into a predetermined number of wet clay bricks; and
activating an electromotor connected to a gear system to rotate a telescopic arm connected to the erect maker sheet;
wherein the telescopic arm converts a rotating motion to a pendulum motion and erects the erect maker sheet along with the wet clay bricks and wherein the erect maker sheet is rotated by 90° to store a horizontally positioned the wet clay bricks into a vertical manner.

3. The method according to claim 1, wherein the loading of the wet clay bricks on a shifter machine comprises:
spraying black oil on the wet clay bricks to move the wet clay bricks from the stock and storage band on to the carrier sheet;
placing a mobile panel of the carrier sheet of the automatic loading and unloading tools around the wet clay bricks on the stock and storage band; and
pulling the mobile panel along with the wet clay bricks on the carrier sheet;
wherein a gradient of the carrier sheet is arranged to be equal to a gradient of the stock and storage band to move the wet clay bricks from the stock and storage band to the carrier sheet.

4. The method according to claim 1, wherein the wet clay bricks strike the sensor after an erection of the wet clay bricks on the stock and storage band and wherein the sensor activates the electromotor to move the stock and storage band in a forward direction by a predetermined distance and wherein the sensor turns off the electromotor for allowing a next row of wet clay bricks to be placed on the stock and storage band.

5. The method according to claim 1, wherein the unloading of the wet clay bricks on a ground comprises:
placing one end of the carrier sheet on the ground by a vertical jack;
placing the mobile panel of the carrier sheet of the automatic loading and unloading tools around the wet clay bricks positioned on the carrier sheet; and
pushing the mobile panel along with the wet clay bricks to the ground.
wherein the shifter machine is moved backward and at the same time the horizontal jack on the automatic loading and unloading tools begins to come forward for fixing one or more rakes on the ground to unload the wet clay bricks on the ground.

6. The method according to claim 1, wherein one or more rakes of the mobile panel are activated by the vertical jacks to fix the mobile panel on the ground for preventing a movement of the mobile panel while unloading the wet clay bricks on the ground.

7. The method according to claim 1, wherein a control mechanism for the automatic loading and unloading tools, fixed in a driver's cabin of the shifter machine is activated to operate the automatic loading and unloading tools.

8. A system for handling processed wet clay bricks, the system comprising:
an erect maker machine for sectioning a wet muddy bar into wet clay bricks and erecting the sectioned wet clay bricks;
a stock maker machine provided with a stock and storage band for storing the sectioned wet clay bricks; and
a shifter machine for shifting the sectioned wet clay bricks from the stock maker machine to a sunshiny area.

9. The system according to claim 8, wherein the erect maker machine comprising:
a section table for driving a wet muddy bar from a press machine and sectioning the wet muddy bar into a predetermined number of wet clay bricks;
an erect maker sheet for placing a sectioned wet clay bricks;
a micro switch for sensing the sectioned wet clay bricks on the erect maker sheet;
an electromotor connected with a gear-box for rotating the erect maker sheet by 90°; and
a telescopic arm connected to the erect maker sheet for converting a rotating motion to a pendulum motion;
wherein the micro switch sends a drive signal to the electromotor to move the telescopic arm connected to the erect maker sheet and wherein the telescopic arm makes the erect maker sheet to rotate by 90 degrees, resulting in erecting the wet clay bricks on the stock and storage band.

10. The system according to claim 8, wherein the stock maker machine further comprising:
one or more sensors to detect the erected wet clay bricks and to activate an electromotor to move the stock and storage band;
one or more pillars for supporting the stock and storage band;
a plurality of rollers connected on either side of the stock and storage band for rotating the stock and storage band; and
a reducer electromotor and a gearbox for controlling a rotation of the plurality of rollers.

11. The system according to claim 8, wherein the stock and storage band is made up of a polyvinyl chloride (PVC) material, which is resistant to an oven oil and gasoline.

12. The system according to claim 10, wherein the plurality of rollers is connected to a reducer electromotor and gear-box by a link for controlling a rotation of the stock band on the plurality of rollers.

13. The system according to claim 8, wherein the shifter machine comprises a frame and wherein the main frame is attached to a main chassis of shifter machine.

14. The system according to claim 9, wherein the frame comprising:
an automatic loading tools for loading the wet clay bricks from the stock and storage band to the shifter machine;
an automatic unloading tools for unloading the wet clay bricks from the shifter machine to the ground at the sunshiny area; and
a hydraulic system.

15. The system according to claim 14, wherein the automatic loading tools comprising:
a carrier sheet for storing the wet clay bricks;
a mobile panel for loading the wet clay bricks from the stock and storage band to the carrier sheet;
a horizontal jack connected to the mobile panel for allowing a horizontal movement of the mobile panel for loading the wet clay bricks from the stock and storage band to the carrier sheet and wherein the horizontal movement of the horizontal jacks is controlled by the hydraulic system; and
one or more vertical jacks connected to the carrier sheet for allowing a vertical movement of the carrier sheet while loading the wet clay bricks from the stock and storage band to the carrier sheet and wherein the vertical movement of the one or more vertical jacks is controlled by the hydraulic system.

16. The system according to claim 14, wherein the automatic unloading tools comprising:
a carrier sheet for storing the wet clay bricks;
a mobile panel for unloading the wet clay bricks from the carrier sheet to the ground;
a horizontal jack connected to the mobile panel for allowing a horizontal movement of the mobile panel for unloading the wet clay bricks from the carrier sheet to the ground and wherein the horizontal movement of the horizontal jacks is controlled by the hydraulic system; and
one or more vertical jacks connected to the carrier sheet for allowing a vertical movement of the carrier sheet while unloading the wet clay bricks from the carrier sheet to the ground and wherein the vertical movement of the one or more vertical jacks is controlled by the hydraulic system.

17. The system according to claim 14 wherein the hydraulic system comprises:
a control handle fixed inside a driver's cabin for activating the horizontal jacks and the one or more vertical jacks; and
a hydraulic pump fixed at an end of a gearbox for pumping an oil to secure a required force for the hydraulic system.

18. The system according to claim 17, wherein the control handles comprises a plurality of levers for controlling the movement of the carrier sheet and the mobile panel.

19. The system according to claim 17, wherein the driver's cabin is placed at a highest point in the shifter machine to view an operation of the horizontal jacks, the vertical jacks and the rakes during a loading and unloading operation of the wet clay bricks and to control a movement of the horizontal jacks, the vertical jacks and the rakes during a loading and unloading operation of the wet clay bricks.
